(19) United States
(12) Patent Application Publication
(10) Pub. No.: US 2005/0039612 A1
(43) Pub. Date: Feb. 24, 2005

(54) Multiple bottom outdoor grill accessory

(76) Inventor: Sean Patrick Denny, Springfield, IL (US)

Correspondence Address: SEAN P. DENNY, 2417 S. 11th STREET, SPRINGFIELD, IL, 62703, US

(21) Appl. No.: 10/924,358

(22) Filed: Aug. 23, 2004

Related U.S. Application Data
(60) Provisional application No. 60/496,773, filed on Aug. 22, 2003.

(51) Int. Cl. A23L 1/00

(52) U.S. Cl. 99/450

(57) ABSTRACT

An apparatus comprised of a base plate, a heat diffuser plate and cooking surface, plate, with or without handles and situated an adequate distance, one above the other, to be used with existing conventional outdoor grill. Plurality spacers located intermittently around the plates provide support and separation. The apparatus is placed directly onto the existing grill and is of sufficient and variant size to hold food for cooking and to fit with an existing grill. This grill accessory is constructed of materials which are not subject to easy degradation by heat produced by outdoor grills and is designed with fixed or removable plates. A variation being an independent outdoor grill that embodies the multiple bottom grill accessory as an intrinsic part of its structure. The multiple bottom grill accessory converts the outdoor grill cooking process to the likes of an oven, thus cooking foods not normally cooked on a grill in a healthier manner.

### FIELD OF INVENTION

The present invention relates generally to the field of outdoor cooking and more particularly to a cooking apparatus that diffuser the heat and elevates the cooking surface to variant heights and is used as an accessory with an existing conventional outdoor grill; or as an independent grill that embodies the invention. The invention first diffuser the heat by means of a multiple bottom system and puts the placement of the food in the upper portions of the cooking chamber of the grill, which allows the foods, including many foods which are more properly baked or not usually cooked on a grill, to be cooked in a method compared to ovens or convection ovens. This invention requires little or no attention during the cooking process and the foods retain their moisture and flavor. If charcoal or wood chips are the choice of grill fuel, the foods acquire that flavor. This invention is equally successful when utilized with a gas or electric fueled grill.

### PRIOR ART

Over the years, the method of outdoor cooking has evolved from cooking over an open campfire to hearth cooking to today's mode of the conventional outdoor grill. Today, the field of outdoor cooking, particularly grilling, has a large variety of cooking equipment available. A well known and very popular being—the conventional outdoor barbecue grill, which is made up of a charcoal container or kettle, a grill and a lid. Commonly, these grills have a cooking rack located above the charcoal holding cavity. Many variations exist as outdoor cooking assemblies of various types have been utilized for many years. It has become evident that a need exists for an apparatus that would convert the conventional outdoor grill into a more versatile and efficient appliance that prepared foods requiring less supervision and in a healthier manner than is currently known.

The current methods of outdoor cooking grills may be fueled by charcoal, gas or electric. The present invention recognizes that smoke influences the taste characteristics of the food greatly when placed on the grill, and that the close proximity of the food on the grill to the heat of the burning fuel, results in rapid cooking, which prevents foods from obtaining a thoroughly desired smoked taste quality. With this invention changing the placement of the food to above the usual cooking location and into the area of the cooking chamber not usually utilized, it not only smokes the food and seals in the flavor, but it also reduces the likelihood of burning or charring. The frequent burning or charring of food addresses another problem associated with cooking on the conventional outdoor grill. While it is believed that burned and charred food is a precursor to cancer, studies have proven that the spacing between the heat source and the food being cooked is a major factor in minimizing the introduction of carcinogens into the foods being cooked over an open fire. The present invention elevates the food away from the heat source and converts the diffuser diffused heat to an indirect heat much like that of an oven but with an even more indirect heat that provided by an oven. There are few if any recipes that say to cook your food on the bottom rack. With the multiple bottom grill accessory you could cook your food on the lower plate and not be concerned about burning. The multiple bottom grill accessory greatly decreases the likelihood of burned or charred food.

It must also be recognized that, regardless of how the grill is fueled, there are limited types of food that can be cooked successfully on the conventional outdoor grill. These limitations again point to a need for an apparatus that will convert the conventional outdoor grill into a more versatile appliance that will cook foods that it is more desirable to bake, such as breads, pies or pizzas and foods that one would not usually associate with grill cooking such as bacon, without burning. A particularly important deficiency in outdoor cooking is the inability to cook pizza. It is well known that pizzas have become an extremely popular American food, with the conventional cooking method for a pizza, whether freshly prepared or frozen, being to place it on an oven rack and bake it. While these are variations to the conventional grill, none of them have provided the diversity of this invention of the outdoor multiple bottom grill accessory. The present invention, by converting the cooking chamber to the likes of an oven, allows one to cook pizza successfully and affords one the option of cooking the crust crispy, if so desired. This invention also provides a method of cooking for baking pies, cookies, breads and numerous other foods not usually cooked on the grill.

Also known of the convention outdoor grill is the necessity to continually supervise or monitor the food being cooked and the exposure to smoke while cooking. While various types of outdoor cooking grills are known to this inventor, none have specifically addressed these situations. This invention allows the user to place the food on the elevated cooking surface plate and close the lid. The food cooks in the normally required cooking time but does not need to be tended again until it is done and ready to serve. By closing the lid to the cooking chamber)the food is surrounded and cooked by the diffused heat and smoke. Also by closing the lid and tending to other matters while the food cooks, the exposure to smoke is eliminated or greatly reduced. The exposure to smoke and the smoke smell can irritate eyes and sinuses, trigger allergies and permeate clothing. With this invention, that exposure is greatly reduced.

Also known to this inventor are fixtures in existence which are adapted to suspend the food above a bed of glowing coals, or the most common grill where food is placed directly on the grill plate, or another which is considered a grill fryer. Many of these grills can easily burn or char the food and often aluminum foil is required in order for the food or meat the retain their moisture and/or flavor. This invention cooks in a manner that allows food to retain their natural juices while remaining tender and succulent, thus having no need for the use of aluminum foil.

Another grill in existence is U.S. Pat. No. 6,314,868 issued Nov. 13, 2001 to David M. Christensen, et al is an outdoor cooker that has a charcoal or gas source of heat. It is equipped with parallel louvers between the heat source and the grill, the louvers can be moved into upright position, or angled position to provide direct or indirect heating to the food. The cooker lacks the ability to cook a variety of foods at the same time. It requires ongoing supervision by the user. The user would have to be adept at judging when and which louvers should be opened for maximum results. This unit does not contain the smoke during the cooking process and cannot adequately cook foods such as pies, pizza and other foods not normally cooked on the grill. The Patent of Christensen cannot be used with an existing grill because it is a unit unto itself.

Another grill is U.S. Pat. No. 5,184,599 issued Feb. 9, 1993 to Clifford H. Stuart. This is a multiple door/tray cooker, smoker grill. It is a self contained cooker grill that has quadrilateral doors with separate cooking grates attached to each door. Closure of all the doors provide a conventional barbecue type cooker or smoker with a full size grate. The various cooking surfaces allows the user to vary cooking times and foods. Again, this device requires much monitoring of the food by the user and is limited as to the type of foods that can be cooked on it. There is no protection from the smoke and even if food were left on some of the cooking shelves, when the doors are open, they would not be over the heat source and the food would not remain warm, or necessarily bug free. This invention is a cumbersome appliance that is difficult to move or store and must be purchased as a separate unit that cannot be used in conjunction with an existing grill. It is comprised of a lot of working parts that could go wrong. There is no diffuser of the heat which would cause the bottom layer to burn if cooking in multiple layers. It is a big cumbersome unit, whereas mine is an accessory and very portable. Mine can be stored on a shelf, this would require more room for storage. Mine utilizes other grill's properties to achieve desired results.

Another grill known to this inventor is U.S. Pat. No. 4,630,593 issued Dec. 23, 1986 to Ernest J. Gremillio. This grill is combined with a fire retarding screen, which is intended to retard flame passage and provide greater heat intensity for cooking foods at a faster rate. The high heat intensity of the screen causing any grease drippings from the food to be dissipated on contact. Their claim is that the outer edges of food cooked, can become crisp and the inner portions remain moist. The unit is designed as part of the grill and is not an accessory to be used with existing outdoor grills. The fire retarding screen does not diffuse the heat nor elevate the food to the upper portion of the cooking chamber. The cooking method, with the fire retarding screen does not change the cooking process nor broaden the types of foods one can cook with it in use. The option of a crispier crust is less obvious than the options available with the multiple bottom grill accessory that I claim. The grill would require continued supervision of the food. It utilizes small holes to retard the heat and it is questionable how effectively that would work, as, it appears, the only way it could diffuse the heat is through burned food. It does not utilize the upper portion of the cooking chamber at all.

U.S. Pat. No. 6,688,301, issued Feb. 10, 2004 to Allen R. McNeill is an accessory for an existing outdoor grill, but for the purpose of prolonging the continuous burring of charcoal, in a charcoal burning grill for slow, low temperature of cooking meat, particularly. The invention of Mr. McNeill separates the coals to around the side but does not diffuse the heat or elevate the food. It does not provide a suitable cooking appliance for the variety of food provided by my invention, nor does it elevate the food to the upper portion of the cooking chamber. It is a known fact that heat rises. Foods such as breads would burn on top and not cook on the bottom. Foods like pizza would burn on the edges and the middle would not cook thoroughly. It would take a lengthy amount of time for bacon to cook on Mr. McNeill's invention. Also with the coals situated around the sides, foods would cook unevenly. With my invention, multiple layers can cook multiple foods at the same time, because mine takes advantage of the fact that heat rises. My invention can be regulated like an oven by the number of briquettes used. The desired texture and tenderness of meat can be achieved with my invention of the multiple bottom grill accessory, with little or no supervision. Supervision would be required with Mr. McNeill's product. The addition of more coals to the fire is inconvenient with the McNeill invention and the unit appears cumbersome to move or store.

Another device known to this inventor is U.S. Pat. No. 5,031,602 issued Jul. 16, 1991 to Edward H. Vick. This is an apparatus for cooking that converts the grill into a bake oven or a smoker. The apparatus has a firebox positioned below a grill and incorporates a closed chamber supported on the firebox and enclosing the grill. A pivotal plate is situated to convert the grill from normal grill fashion cooking to an oven. The pivotal plate is a singular plate which heats up as hot as the fuel source under it which can still burn the food. My invention has a multiple bottom diffuser system, whereas, my base plate gets very hot but the heat is then diffused around the second plate and up to the cooking area, completely avoiding direct heat. While it is claimed that Mr. Vick's invention protects the user from smoke, the process of eliminating the smoke involves several adjustments of the flue and the vent. The invention being discussed is a unit unto itself and cannot be utilized with an existing outdoor grill. It is costly. The advantages of my invention of the multiple bottom grill accessory over Mr. Vick's invention, are many, but one most significant advantage is the ease with which an existing grill can be converted into a cooking appliance like an oven.

Various inventions known to this inventor include U.S. Pat. No. 6,062,131 issued May 16, 2000 to Robert B. Holland, U.S. Pat. No. 6,487,964 issued Dec. 3, 2002 to Phillip Jack Snoke and U.S. Pat. No. 5,359,923 issued November, 1994 to Burl Boswell are all variations and adaptations to the existing outdoor grill. They claim a roasting stand for a chicken within a cooking apparatus such as an outdoor grill, smoker and cooker with adjustably spaced grills with a water pan steamer assembly and an apparatus for cooking meat that contains at least one liquid container that acts to marinade or flavor the meat respectively. While these inventions all act in a way to improve the taste of foods cooked, particularly meat, they do not encompass the various advantages the multiple bottom grill accessory has.

The U.S. Pat. No. 4,384,513 issued May 24, 1983 to Richard L. Pierick is an apparatus for preparing pizza in a baking oven. This apparatus is for use with an indoor oven and relates to my invention because it improves or perfects the results of cooking the pizza. It has a hole in the middle for the purpose of thawing, mine cooks pizzas outdoors like it were cooked indoors, with no need for thawing the pizza before it is cooked. The advantage of my invention, over Mr. Pierick's invention are that the pizza can be cooked on an existing outdoor grill with the multiple bottom grill accessory and that the double bottom grill accessory affords one the option of browning the crust or cooking it regularly. The cooking would require little or no supervision and the process would be relatively bug free. The invention being compared deflects the heat off te bottom, whereas the heat is absorbed in my invention.

Another invention is U.S. Pat. No. 6,016,797 issued Jan. 25, 2000 to Frank L. Nowicke Jr. This is for a barbecue grill with smoker and water conversion. It is for rendering a barbecue grill cooker into a smoker equipped with a water pan. The limitations on this are apparent in that it limits the foods cooked to those the user would want smoked. There is no means or conversion to cook foods not normally cooked on an outdoor grill. Another disadvantage to Mr. Nowicke's invention is that it is not compatible with an existing outdoor grill but must be purchased as a unit unto itself.

The U.S. Pat. No. 6,543,435 issued Apr. 8, 2003 to Paul Lewis Regen and Everett Harold Hale is for collapsible multi-level barbecue grill, oven and smoker. It is a small grill that is readily portable and employs the various features of a grill, a smoker and an oven. While the grill is portable, it is not as easily portable as mine, when mine is used as an accessory to an existing grill. Cleaning of this ringed cooker seems very difficult whereas mine can be put in the dishwasher in parts or as a whole when used as an accessory. When food build up is thick, mine can be tapped on a hard surface to dislodge most food stuff. Also with mine, food stuff build up on the diffuser plate acts greatly like the flavor rods that do the flavoring in a lot of gas grills. The invention of Mr. Regen and Mr. Hale do none of that.

Another invention known to this inventor is U.S. Pat. No. 4,750,469 issued Jun. 1, 1988 to Duane L. Biggs. This invention is an operated controlled means to enhance the efficiency of barbecue grill systems. This invention includes multiple groups of independent louvers which are pivotally attached to the frame and which interconnect to cause them to move in unison when moved by the operator. The heat from the burning charcoal can have direct access to food being cooked or radiant heat from the heated louvers can replace the direct heat. A combination of direct and radiant heat can also be arranged. The louvers only partially diffuse the heat. Once the louver heat up they are just as hot as a solid plate and will burn foods placed on them. Whereas my multiple bottom grill accessory will not burn the food on the cooking surface plates. Also the invention of Mr. Biggs does elevate the foods to the more proper height like mine does, thus the variety of food cooked on mine is broader. The louvers will become clogged in time with burned food and become non working. Mine, because of its unique design is easily cleaned and there are no parts that would require replacement, with proper use.

### SUMMARY OF THE INVENTION

The general purpose of the present invention, which will be described subsequently in greater detail, is to provide a healthier and more efficient method of cooking a larger variety of foods by diffused heat on an existing outdoor grill, by adding the present invention grill accessory or by utilizing this invention as an independent grill of which this invention is an intrinsic part of its structure.

The present invention is a multiple bottom grill accessory to be used as an addition to an existing conventional outdoor grill or another embodiment is an independent outdoor grill that comprises the same apparatus and affords the same benefits as the multiple bottom grill accessory used with an existing conventional outdoor grill. This present invention is constructed of metal or any type of materials not subject to easy degradation by the heat produced by outdoor grills. It comprises a series of plates that sit directly on the cooking grate of an existing grill over the burning charcoal or other heat source. The placement being made after the fire in the grill is established. The plates are adequately spaced, one above the other and of sufficient size and shape to hold the food and accommodate easily with an existing outdoor grill. The base plate sits directly on the existing grill's cooking grate. Above the base plate is the diffuser plate and above the diffuser plate is the cooking surface plate or plates. The plates are separated and divided by plurality spacers located intermittently around the plates, as needed for support. The present invention is designed with a means for the plates to be fixed in place or removable. The plates may or may not have handles, built in or attachable. The multiple cooking surface plates would enable the user to cook several layers simultaneously.

The present invention advantageously provides a cooking apparatus and method that cooks foods that are not usually on an outdoor grill. This is achieved by elevating the food cooking surface to the usually unused upper area of the cooking chamber, diffusing the heat and cooking with the lid closed. This converts the method of cooking from that normally associated with grill cooking into the method similar to that of an oven or convection oven. This process requires little or no supervision by the user. Once the food has been placed on the cooking surface plate, the user may close the lid and not tend the food again until it is done and ready to serve. The food is cooked the normally required cooking time. By cooking with the lid closed, the user is not exposed to the smoke as they would be with a conventional grill alone. The food is exposed to the diffused heat in the upper chamber of the grill. This conversion of heat enables the user to cook many foods on the multiple bottom grill accessory that would not normally be cooked on a grill. An additional benefit is, this method of cooking greatly inhibits or prevents charring or blackening during the cooking process. Since it is recognized that burning and charring are a precursor to cancer, this is indeed a benefit. The juices in meat and the taste of foods can be varied by simply changing the charcoal or by adding different wood chips that are used in the fuel.

Accordingly, it is a principal objective of the invention to provide an improved, more advantageous, convenient and healthier means of cooking food on an outdoor grill that includes foods not normally cooked on an outdoor grill. A further objective is foods can be cooked with little supervision in a comparative smoke free environment. Thus the reader will also see that the multiple bottom grill accessory provides an extended use for currently existing outdoor grills by converting it into a more diverse cooking instrument. The conversion requires no tools, hooks or fasteners. A more thorough description of objects can be read under that heading.

### OBJECTS AND ADVANTAGES

Accordingly several objects and advantages of my invention are:

A major objective of this invention is to provide a more efficient way of cooking a larger variety of foods on an outdoor grill. This is accomplished by converting the existing outdoor grill into a cooking method similar to that of an oven or convection oven with the addition of this grill accessory. It is also accomplished by the use of this invention as an independent grill which encompasses the grill accessory as an intrinsic part of its structure.

The conversion of the cooking process is made possible by a multiple bottom grill accessory which diffuses the heat. The grill accessory also elevates the food to the upper portion of the previously unused portion of the cooking chamber. This improved method of cooking on an outdoor grill enables the user to cook pizza, cookies, bacon, pies and many more foods that were not previously recognized as food to be cooked on an outdoor grill. It also seals in the juices in meat.

Another objective is to provide a healthier means of preparing food on an outdoor grill. The diffusion of the heat and the elevation of the food to the upper portion of the cooking chamber, distances the food from the direct heat source, cooks the food in a more forgiving manner that greatly reduces the likelihood of burning and charring. As it is believed that burning and charring is a precursor to cancer, this provides a healthier way to prepare foods cooked on an outdoor grill. The foods are also more juicy and more tasty than fried foods.

Yet another objective is to enable to user to cook in a comparative smoke free environment. The present invention is placed on the grate of an existing grill, the food is placed on the cooking surface plate of the present invention and the lid to the grill is closed during the cooking process because constant tending is not required. This greatly reduces the exposure to smoke normally associated with outdoor grill cooking. The reduction of smoke exposure and reduces the irritation of eyes and sinuses, is less likely to trigger allergies and reduces the smoke smell that would usually permeate the clothing of the grill user.

A further objective is that food can be cooked with little or no supervision as the indirect heat provides a more uniform cooking process. Once the grill is fired, the present invention placed on the grate, the food placed on the cooking surface of the present invention, the lid to the grill is closed. The food is cooked the normally required cooking time and does not need to be tended until that time has elapsed. This convenience allows the user time to prepare other foods, visit with guest or engage in activities of their choice while the foods cook virtually unattended.

Yet another objective is that the utilization of this invention affords people who are inexperienced at grill cooking to become a more accomplished grill cook. The simplicity of placing the food on the cooking surface plate of this invention and closing the lid, makes cooking easier and requires no former experience or knowledge of outdoor grill cooking. For example, whereas outdoor cooking has long been recognized as primarily a male gender achievement, the present invention would enable the female gender to become equally accomplished.

An additional objective is for this present invention to act as an insect or bug retardant. When the food is cooked and the lid is opened, the food can remain on the cooking surface plate of this present invention. The diffused heat rising around the grill accessory repels the bugs but the food will not burn as would be expected were it left on the grate of a conventional outdoor grill.

Yet another objective is this present invention to act as a food warmer. Again, when the food is cooked and the lid is raised and the food remains on the cooking surface plate, the cooking does not continue when the lid is raised, but the heat still being provided by the fuel source will keep the foods warm. The food can be left there during serving or for whatever reason desired, as the diffused heat and elevation of the food prevents the food from burning as would be expected were it left on the grate of a conventional outdoor grill.

Still another objective is to afford the user to adjust the flavor of the foods being cooked by changing the fuel source. For example, charcoal, apple chips, hickory chips, etc. can influence the flavor of the food being cooked. The method of cooking accomplished by the use of this present invention allows the smoked flavor to permeate the food without overcooking or burning.

Another objective of the present invention is to provide a grill accessory that is inexpensive, dependable and fully effective in accomplishing its intended purpose.

A still further objective of the present invention is to provide an outdoor grill accessory that can be utilized with an existing grill.

A further objective is that the present invention can be utilized with an existing grill without the use of brackets, a screw driver or any other took, as the present invention sets directly on the grate of an existing outdoor grill unless designed as an independent grill unto itself.

An advantage is there are no moving parts which reduce the need for repair or the possibility of the multiple bottom grill accessory not working correctly.

Another advantage is that after reading the directions, and with a little practice, the heat can be calibrated by the number of briquettes.

Yet a further advantage is the multiple bottom grill accessory can be cleaned with a grill brush, in the dishwasher or by tapping it on a solid surface to dislodge the food build up.

Another advantage is that the food run off left on the accessory acts like the flavor rods in gas grills and could remain on for more flavor.

A great advantage is that when direct grilling is wanted, the multiple bottom grill accessory can be stored on a shelf in a small space in the garage or otherwise.

These and other objects of the present invention will become readily apparent upon further review of the following specifications and drawings.

### BRIEF DESCRIPTION OF THE DRAWINGS

This invention is better understood from the following descriptions taken in conjunction with the accompanying drawings and in the claims and objectives.

FIG. 1 is a general view of the present invention of the multiple grill accessory as a unit to be used with an existing conventional outdoor grill.

FIG. 2 is an isometric exploded view of the multiple bottom grill accessory as a unit to be used with an existing conventional outdoor grill.

FIG. 3 is a cutaway view of the present invention multiple bottom grill accessory placed on the cooking grid, as it would be used in conjunction with an existing conventional outdoor grill.

FIG. 4 is an isometric exploded view of the present invention of the multiple bottom grill accessory designed as an independent grill.

FIG. 5 is an isometric exploded view of the present multiple bottom grill accessory with the variation of a perforated diffuser plate.

FIG. 6 is an isometric view of the present multiple bottom grill accessory which includes the variation of the opposing diffuser plate covering the perforated diffuser plate.

### DETAILED DESCRIPTION OF THE PREFERRED EMBODIMENTS

The present invention comprises various embodiments of the multiple bottom grill accessory which is an apparatus and method of using the apparatus that diffuses the direct heat and utilizes the cooking area above the grill rack of a conventional outdoor grill. By positioning the food in that area, with the present invention, foods are cooked in a method similar to that of an oven or convection oven. The present invention elevates the food, diffuser the heat and cooks the food in an enclosed chamber.

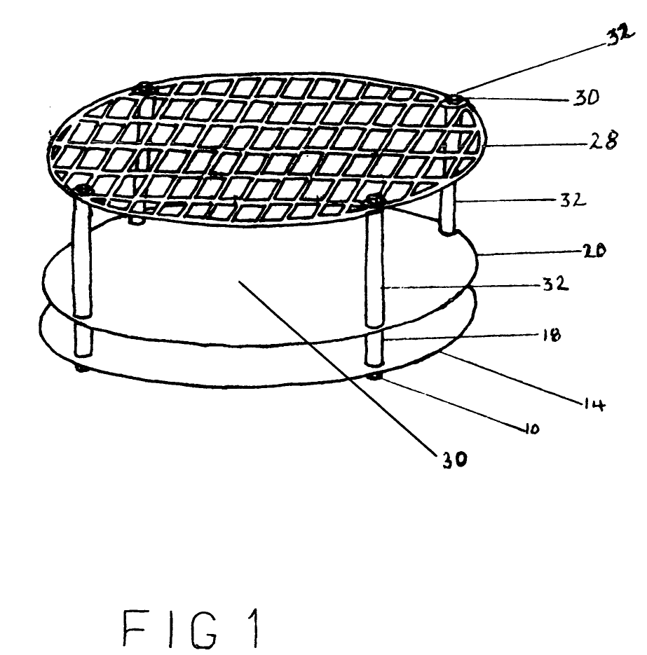

FIG. 1 illustrates the general view of the present invention of the multiple bottom grill accessory [26] as a unit to use with an existing outdoor grill.

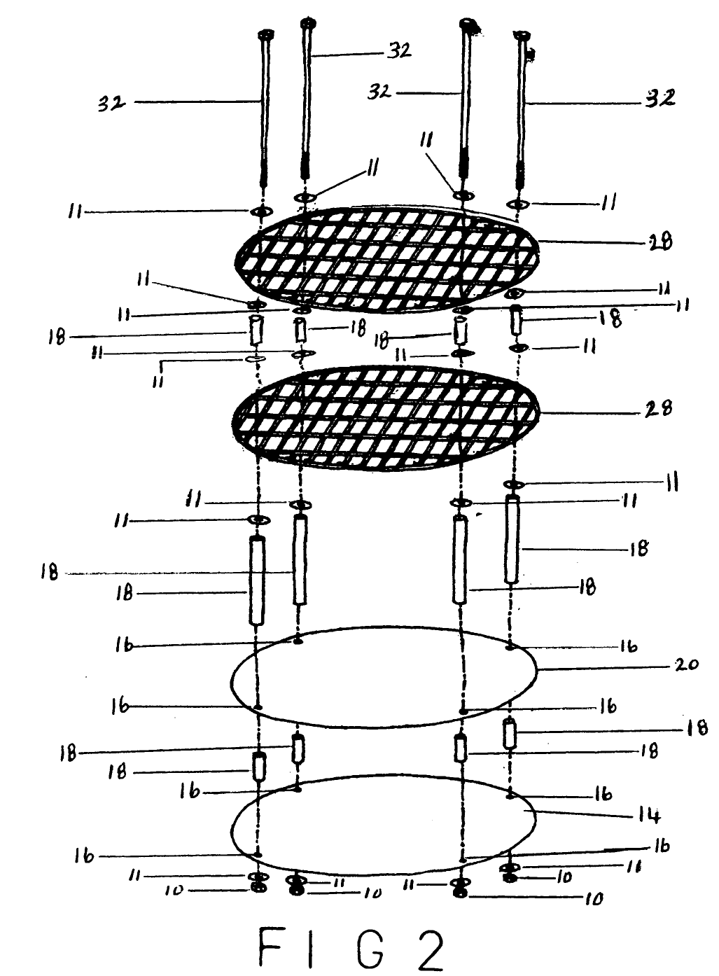

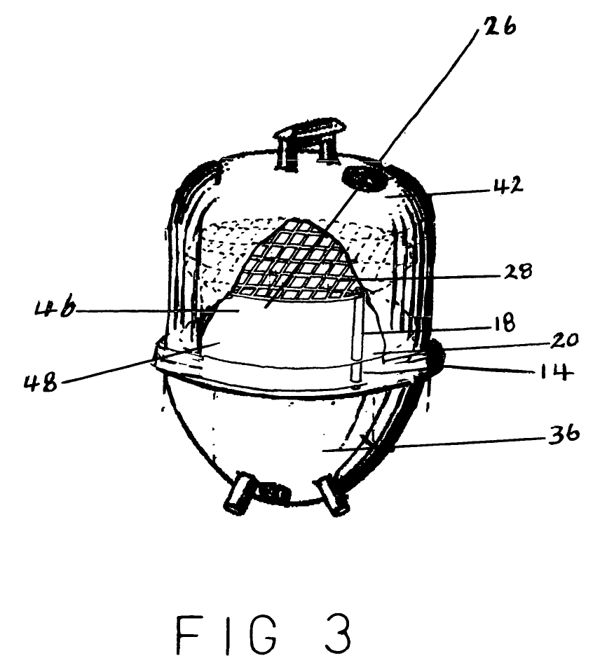

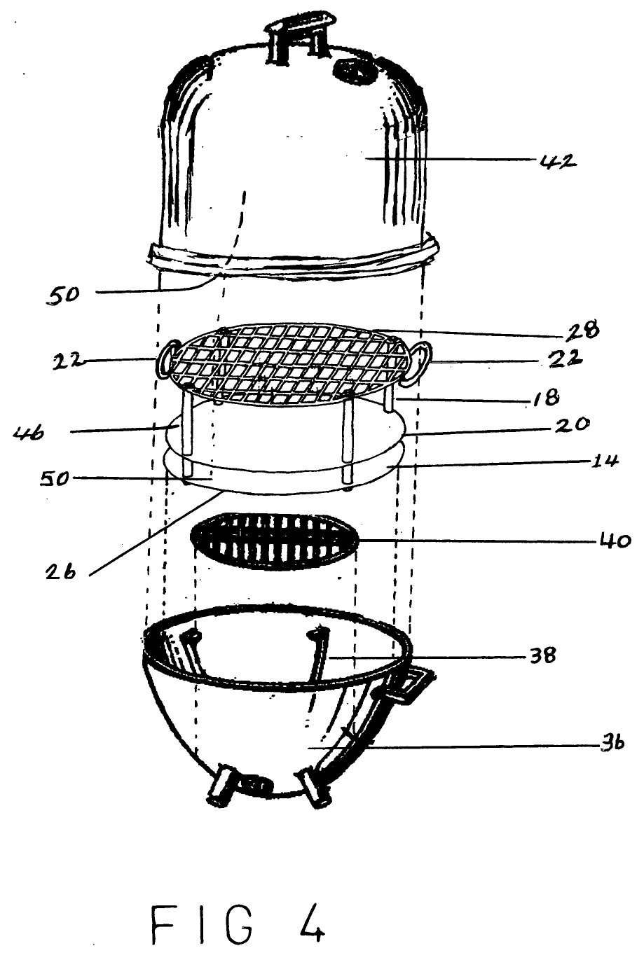

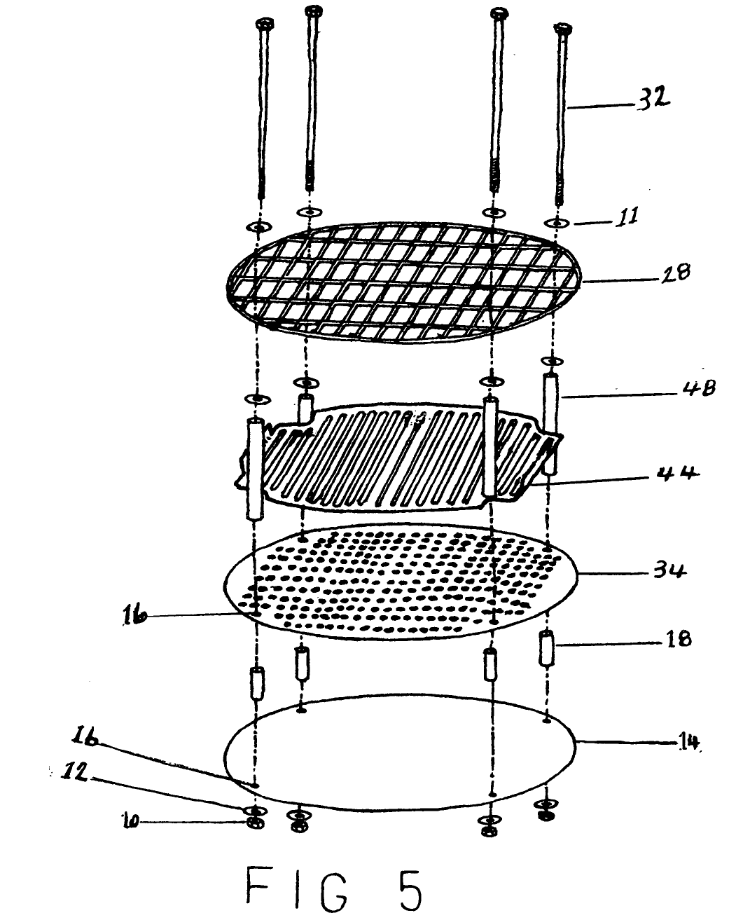

FIG. 2 illustrates an isometric exploded view of the grill accessory as a unit to be used with an existing outdoor grill. The isometric view in FIG. 2 of the present invention of the grill accessory as a unit to be used with an existing conventional outdoor grill is the first embodiment of the present invention. Wherein, the multiple bottom grill accessory apparatus is constructed of metal or any material that is not subject to easy degradation by heat. The present invention consists of a series of plates [14, 20, 28] spaced one above the other. The plates may or may not have handles [22], the handle may be attached or built in. The base plate [14] sets directly on the existing conventional outdoor grill, upon the grate on which food is normally placed for cooking. The invention is situated over the burning coals or other heat source of the existing grill. The base plate [14] constructed of the heat resistant material, is most effective as a solid material, but the material may vary to include waffled, scored or other variations. The base plate [14] is attached and separated from the diffuser plate [20] which is situated an adequate distance above the base plate [14]. The plates [14, 20] are separated and supported by spacers [18]. One method of construction is, the spacers [18] are attached and secured to the base plate [14] by a nut [10] with the use of a washer [12] with the spacer [18] placed through the hole [16] which is for that purpose alone. This is but one embodiment of the method of separating and supporting the diffuser plate [20] from the base plate [14]. The diffuser plate [20] may be constructed of the same solid non heat degradation material as the base plate [14] or another heat resistant material. To provide more variance in cooking the diffuser plate [20] may vary as shown in FIG. 4 and FIG. 5. The diffused heat [50] circulates up and around the diffuser plate [20] to the upper most part of the cooking chamber and the cooking surface plates [28] in a manner utilizing the natural convection present in outdoor grills. Situated an adequate distance above the diffuser plate [20] is one or more cooking surface plates [28]. The cooking surface plate [28] is separated and supported by the same means as the base plate [14] and the diffuser plate [20] are separated and supported. Most commonly, the diffuser plate spacer [18] is placed through holes [16] and threaded or attached by other means to the base plate spacer [18]. The use of a washer [12] may be used between the diffuser plate spacer [18] and the cooking surface plate [28]. The cooking surface plate [28] is secured to the diffuser plate [20] and the diffuser plate spacers [18] by connecting bolts [32] and washers [12]. The connecting bolts [32] and the diffuser plate spacer [18] having an internal mating attachment area providing positive attachment. The means [48] of separating and supporting the various plates is not limited to the method described. FIG. 3 is a cut-away view of the present invention multiple bottom grill accessory [26] placed as it would be used in conjunction with an existing conventional outdoor grill. The entire apparatus [26] is pictured setting on the top grate of an existing outdoor grill as it would be placed when in use. The present invention includes a means [46] for the plates [14, 20, 28, 34, 44] to be raised or lowered, one at a time or as a unit as well as a means [24] for removing the plate or plates [14, 20, 28, 34, 44] during use and for cleaning purposes.

FIG. 4 is an isometric exploded view of another important embodiment of the present invention multiple bottom grill accessory. This view shows the present invention designed as an intrinsic part of an independent grill. The independent grill would encompass the same features and parts as the invention shown in FIG. 1, FIG. 2, FIG. 3, or FIG. 5 or when the invention [26] is used as an accessory to an existing conventional outdoor grill. The general construction of the multiple bottom grill accessory for an independent grill, is the same as described in FIG. 2 with the same unlimited variations. The independent grill as shown in FIG. 4, would include a kettle [36] and a lid [42]. Both being of a design similar to what would be found with any existing outdoor grill. The kettle [36] being equipped with built in brackets [38] that extend above the floor of the kettle [36] an adequate distance to support the charcoal holding grate [40]. The invention [26] is designed to fit compatibly onto the charcoal holding grate of this embodiment.

FIG. 5 is an isometric exploded view of the present multiple bottom grill accessory depicting the variation of a perforated diffuser plate [34] and an accompanying opposing diffuser plate [44]. The perforated diffuser plate [34] is located in the same space and proximity as the original diffuser plate [20]. The difference being the perforated diffuser plate [34] has adequately spaced holes throughout the surface of the plate to allow browning certain foods darker, when a crispier crust or other crispier foods are desired. This variation also would include a separate opposing diffuser plate [44] with openings that align with the perforated holes on the perforated diffuser plate [34] so that it may be shifted to cook with the holes open or to close the holes for total diffusion when extra browning or crispness is not desired. Also shown in FIG. 5 is an optional and removable drip pan [30] designed to collect grease drippings and other food runoffs. The optional removable drip pan [30] is situated below the diffuser plate [20], [34, 44] and above the base plate [14]. The optional drip pan [30] may be a selected part of either the multiple bottom grill accessory as used with an existing grill or the independent multiple bottom grill accessory.

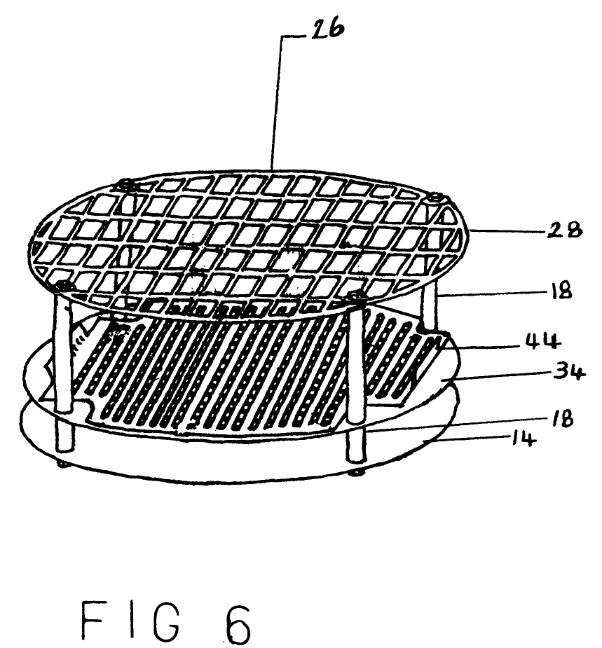

FIG. 6 is an isometric view of the present multiple bottom grill accessory which depicts the variation of the opposing diffuser plate [44] covering the perforated diffuser plate [34].

While my description contains many specifications, these should not be construed as limitations of the scope of the grill accessory invention, but rather as an exemplification of descriptions of the preferred embodiments. Many variations are possible. For example, the present invention [26] could include more than one base plate [14] and/or more than one diffuser plate [20]. Another variation of the perforated diffuser plate could include a cover plate that also has perforations but the perforations are in opposing placement, so the holes can be over one another to allow for the extra browning or with a slight shifting of the perforated cover plate [34], the holes would not be aligned with each other and the holes would be closed to allow regular diffused cooking of the food. Another variation is the cover plate could be a separate and removable piece that is placed over the perforated diffuser plate [34] when browning is not desired. The cooking surface plate [28] could have one above the other which would allow several layers to cook simultaneously. They could be attached and supported [48] by a variation of the plate spacer [18] or a variation of the connecting bolt [32] or by other suitable means [48]. Another variation would include handles constructed as a part of the base plate [14], diffuser plate [20] and/or surface plate/plates [28], or handles that are attachable and removable. Still another variation of this invention would be the size and shape of the base plate [14], the diffuser plate [20], and the cooking surface plate/plates [28]. Size could vary from round to square to oval to small enough for cooking a single serving to large enough to cook enough food for a crowd, as long as the size does not exceed the space needed for the invention to fit within an existing conventional outdoor grill. While another variation of this invention would include a means [46] for raising and lowering the cooking surface plate/plates [28] to a desired distance above the diffuser plate [20] in which to accommodate the food being cooked more efficiently.

Accordingly, the scope of the invention should be determined by the embodiments described as well as illustrated.

### Drawing Reference Numeral Guide

10. nut
11. washer
14. baseplate
16. hole
18. spacer
20. diffuser plate
22. handles
24. means for removing plate/plates
26. entire multiple bottom grill accessory
28. cooking surface plate
30. optional drip pan
32. connecting bolt
34. perforated diffuser plate
36. kettle
38. brackets
40. charcoal holding grate
42. lid
44. opposing diffiser plate
46. means for raising and lowering plates
48. means of support and separation of plates
50. diffusion of heat

1. A grill accessory apparatus for use with an existing outdoor grill, or constructed as an independent outdoor grill of which said accessory apparatus is an intrinsic part of the independent grill's features. Said apparatus, comprising a series of plates, one above the other, made of any material which is not subject to degradation by heat produced by outdoor grills and being of variant size and shape to hold food for cooking and to fit within an existing outdoor grill. Said plates may be removable or fixed, having or not having built in or attachable handles, with the structure of the invention being the same whether as an accessory to an existing outdoor grill or as an independent grill that embodies the grill accessory's unique series of plates as part of its construction.
a base plate or bottom surface that sets directly on the existing grill plate
a diffuser plate being adequately spaced above said base plate so as to act as a diffuser of the direct heat from said base plate
a cooking surface plate or plates, spaced an adequate distance above said diffuser plate
the method of cooking in the space under the dome of the closed grill that is created by elevation of said cooking surface and diffused heat created by said multiple bottom apparatus
the system of said multiple plates and spaces that in turn comprises said invention in outdoor grills and/or accessories or in indoor grills

2. Said grill accessory according to claim 1, wherein said apparatus, after diffusing the heat via said base plate and said diffuser plate combination, elevates said cooking surface plate to the upper areas of the cooking chamber where foods are not normally cooked, which allows foods to cook in a method similar to the cooking method provided by an oven
foods not normally cooked on an outdoor grill can be properly baked or cooked on an outdoor grill utilizing said multiple bottom grill accessory apparatus
that with the use of said multiple bottom grill accessory, cooking the foods will require little or no supervision during the cooking process
the likelihood of burning or charring of food is greatly reduced by cooking with diffused heat created by use of said multiple bottom grill accessory
said base plate, said diffuser plate and said cooking surface plates being supported and separated by said spacers
said spacers being perpendicular to said plates and placed intermittently between said plates
a means within said grill accessory apparatus that acts as a guide for holding said plates thus allowing said plates to be fixed in place or removable
any additional said plates, said diffuser plates or said cooking surface plates that are spaced upward or otherwise utilize the same concept and construction but may be separated and supported by different means
any variations of said construction of said apparatus including the perforation of said diffuser plate with a variety of corresponding cover plates
an optional and removable drip pan to catch food run off and a means for securing said drip pan
any device that utilizes and separates said metal plates for diffusion of heat for cooking
indirect heating will reduce the carcinogenic effect that charred foods have on the human system thus providing a preferred healthier means of cooking
the smoke more thoroughly permeates the food being cooked when said invention is utilized thus providing a more flavorful food
that when meats are cooked on said invention, they retain their juices and are not blackened or stringy as when cooked over direct heat of a conventional grill
said invention acts as a food warmer when left on the grill after the food is cooked and the lid is open and the coals remain hot
said invention acts as a means to keep the food bug free
said grill accessory requires cooking with lid closed which also reduces exposure, irritation, and smell of smoke to the user
the method of cooking with said apparatus provides a healthier food as opposed to fried or grilled
